(19) United States
(12) Patent Application Publication
(10) Pub. No.: US 2026/0170078 A1
(43) Pub. Date: Jun. 18, 2026

(54) COHERENT SOLVERS FOR BOOLEAN SATISFIABILITY PROBLEM SOLVERS

(71) Applicant: NTT RESEARCH, INC., SUNNYVALE, CA (US)

(72) Inventors: Sam REIFENSTEIN, SUNNYVALE, CA (US); Timothy McKENNA, SUNNYVALE, CA (US); Marc JANKOWSKI, SUNNYVALE, CA (US); Myoung-gyun SUH, SUNNYVALE, CA (US); Edwin NG, SUNNYVALE, CA (US); Yoshihisa YAMAMOTO, SUNNYVALE, CA (US)

(73) Assignee: NTT RESEARCH, INC., SUNNYVALE, CA (US)

(21) Appl. No.: 19/123,633

(22) PCT Filed: Oct. 24, 2023
(86) PCT No.: PCT/US2023/077650

§ 371 Date: Apr. 23, 2025

Related U.S. Application Data
(60) Provisional application No. 63/418,617, filed on Oct. 24, 2022.

(51) Int. Cl. G06F 17/11

(52) U.S. Cl. CPC G06F 17/11

(57) ABSTRACT

Embodiments disclosed herein are directed computing systems for solving Boolean satisfiability (SAT). In some embodiments, the computing systems may be all-optical computing systems. Operations within the computing systems may be based on an optical encoding of a Boolean SAT problem, particularly for performing matrix-vector or vector-vector multiplication in an optical domain. An optical random access memory may include a plurality to individually addressable optical cavities, each cavity storing a corresponding variable as resonating optical pulses. The optical domain computations may be performed by offset circuits that provide an offset to variables loaded from the optical random access memory, multiply and accumulate circuits that generate products of the offset variables, and feedback circuits that feed back the products to the optical random access memory.

### PRIORITY

This application claims priority to U.S. Provisional Patent Application No. 63/418,617, filed Oct. 24, 2022, and entitled “Coherent Solvers for Boolean Satisfiability Problem Solvers,” which has been incorporated by reference in its entirety.

### FIELD

This disclosure relates to methods and systems for solving Boolean satisfiability (SAT) and a hardware implementation thereof. The methods and systems can be further generalized to other solvers as well.

### BACKGROUND

Combinatorial optimization is ubiquitous across diverse fields of science, engineering, medicine, and finance. Particular examples of where a combinatorial optimization is used include drug discovery, machine learning, compressed sensing, scheduling, logistics, circuit design, and communication networks. A possible numerical approach to achieve a combinatorial optimization is to map a corresponding combinatorial optimization problem to the Ising model and solve the problem with an Ising machine. Formally, the Ising model is defined by the Hamiltonian,

$$H = - \frac{1}{2} {\sum }_{i} {\sum }_{j} {σ}_{i} {σ}_{j} {J}_{i j} ,$$

with a set of discrete spins σᵢ∈{−1, +1}. Finding spin configurations that minimizes the Hamiltonian is an NP-hard problem and is very difficult on digital computers. As a result, significant efforts have been invested toward leveraging various physical systems, such as Ising machines.

While some combinatorial optimization problems are efficiently mapped to the Ising model, other problems require substantial overhead, i.e., many additional spins for proper mapping. For instance, to solve Boolean Satisfiability (SAT) problems and Maximum Satisfiability (Max-SAT) problems by first mapping them to Ising models and subsequently solving them using Ising machines may not necessarily be competitive against various SAT solvers on digital platform.

### SUMMARY

In some embodiments, an optical computing system is provided. The optical computer may include an optical random access non-transitory memory. The optical random access non-transitory memory may include a plurality of optical cavities, each optical cavity is configured to store a variable as resonating optical pulses. Each optical cavity is optically connected to: an input rail configured to provide an input to the optical cavity, a signal rail configured to provide a read/write signal to the optical cavity, and an output rail configured receive an output from the optical cavity. A first optical cavity of the plurality of optical cavities may be configured to output a first train of pulses in response to a first read/write signal, the first train of pulses representing a first sub-term of a first vector, and the first read/write signal being based on a sparsity of the first vector. A second optical cavity of the plurality of optical cavities may be configured to output a second train of pulses in response to a second read/write signal, the second train of pulses representing a second sub-term of a second vector, and the second read/write signal being based on a sparsity of the second vector. The optical computing system may also include an optical processing circuit. The optical processing circuit may include a first offset circuit configured to offset the first sub-term and a second offset circuit configured to offset the second sub-term, a multiply and accumulate circuit configured to generate a product of the offset first sub-term and the offset second sub-term, and a feedback circuit configured to feed back the product to the optical random access non-transitory memory.

In some embodiments, a method performed by an optical computing system may be provided. The method may include outputting, by a first optical cavity of a plurality of optical cavities forming an optical random access non-transitory memory, a first train of pulses in response to a first read/write signal, the first train of pulses representing a first sub-term of a first vector, and the first read/write signal being based on a sparsity of the first vector. The method may also include outputting, by a second optical cavity of the plurality of optical cavities, a second train of pulses in response to a second read/write signal, the second train of pulses representing a second sub-term of a second vector, and the second read/write signal being based on a sparsity of the second vector. The method may further include offsetting, by a first offset circuit, the first sub-term to generate an offset first sub-term and offsetting, by a second offset circuit, the second sub-term to generate an offset second sub-term. The method may additionally include generating, by a multiply and accumulate circuit, a product of the offset first sub-term and the offset second sub-term and feeding back, by a feedback circuit, the product to the optical random access non-transitory memory.

### BRIEF DESCRIPTION OF DRAWINGS

FIG. 1A shows an example optoelectronics circuit, according to example embodiments of this disclosure.

FIG. 1B shows an example optoelectronics circuit to calculate feedback term for the optoelectronics circuit shown in FIG. 1A, according to example embodiments of this disclosure.

FIG. 1C shows the specific optical encoding in the optoelectronics circuit shown in FIG. 1A, according to example embodiments disclosed herein.

FIG. 2 shows charts showing the empirical results of a Monte-Carlo simulation for the optoelectronics circuit shown in FIG. 1A, according to the example embodiments of this disclosure.

FIG. 3 shows an example parallelized optoelectronics circuit, according to example embodiments of this disclosure.

FIG. 4 shows an example all-optical computing system, according to example embodiments of this disclosure.

FIG. 5 shows the details of an example multiply and accumulate circuit, according to example embodiments of this disclosure.

FIG. 6 shows an example memory configured to optically store a variable, according to example embodiments of this disclosure.

FIG. 7 shows an example optical random access memory, according to example embodiments of this disclosure.

FIG. 8 shows a layout of an optical chip, according to example embodiments of this disclosure.

FIG. 9 shows a flow diagram of an example method of optical computing, according to example embodiments of this disclosure.

### DESCRIPTION

Embodiments disclosed herein are directed computing systems for solving Boolean satisfiability (SAT). In some embodiments, the computing systems may be all-optical computing systems. Operations within the computing systems may be based on an optical encoding of a Boolean SAT problem, particularly for performing matrix-vector or vector-vector multiplication in an optical domain. An optical random access memory may include a plurality to individually addressable optical cavities, each cavity storing a corresponding variable as resonating optical pulses. The optical domain computations may be performed by offset circuits that provide an offset to variables loaded from the optical random access memory, multiply and accumulate circuits that generate products of the offset variables, and feedback circuits that feed back the products to the optical random access memory. As further detailed below, such all-optical computing systems are significantly efficient and faster than conventional digital computing systems.

Given a Boolean formula over a set of N variables, the Boolean SAT problem may ask if there is an assignment of the variables in which the formula outputs a “True” state. Boolean formulae may generally be expressed in a conjunctive normal form (CNF), as described below. N binary variables, hereinafter called literals l₁, l₂, l₃, . . . lₙ, may be defined, where lᵢ∈{0, 1}, i.e., a literal lᵢ takes the binary value of either 0 or 1. M clauses may be further defined, where each may contain k literals (in this specific example k=3 literals). An example clause can be (l₁∨l̅₂∨l₅), where ∨ denotes a logical OR statement and the overbar (e.g., as shown in l̅₂) denotes a logical NOT statement. A conjunctive normal form formula may include a conjunction (AND operation, denoted by ∧ below) set of M clauses with k literals, wherein each clause is a disjunction (OR operation) of the literals, either as negated variable (NOT operation) or non-negated variables. Conjunctive normal form may be used in the embodiments because any arbitrary Boolean formula can be converted to an equivalent formula with only a linear overhead. For example, the following conjunctive normal form shows 5 literals and 2 clauses:

$$( {l}_{1} ⋁ \overline{{l}_{2}} ⋁ {l}_{5} ) ⋀ ( {l}_{2} ⋁ {l}_{3} ⋁ \overline{{l}_{4}} )$$

The solution is to find a set of literals that simultaneously satisfies all M clauses.

It is to be noted that a conjunctive normal form SAT formula where each clause may have exactly K clauses is known as a K-SAT formula and the K-SAT problem is known to be NP-complete if K≥3.

Each literal l can be associated with a spin x such that:

$${x}_{1} , {x}_{2} , … , {x}_{N} \qquad {x}_{i} ∈ [ - 1 , 1 ]$$

$${l}_{i} = ( 1 + {x}_{i} ) / 2$$

The coupling matrix cᵢₘ for a SAT problem can be defined as follows:

$${c}_{im} = \{ \begin{matrix}+ 1 & if {l}_{i} is in clause m \\ - 1 & if \overline{{l}_{i}} is in clause m \\ 0 & if the ith variable is not included in clause m\end{matrix}$$

Although the embodiments disclosed herein use a closed-loop SAT-chaotic feedback control (CFC) algorithm to solve the problem, the below description describes an open-loop solution (i.e., without the error term), which may be easy to generalize. In the open-loop system, each spin xᵢ may evolve according to the following expressions:

$${\partial }_{t} {x}_{i} ( t ) = ( p - 1 ) {x}_{i} ( t ) - {x}_{i}^{3} ( t ) - {𝓏}_{i} ( t )$$

$${𝓏}_{i} ( t ) = {\sum }_{m} {K}_{im} ( t ) ,$$

where Kᵢₘ may be a mutual coupling matrix and where zᵢ(t) may be the feedback term. The mutual coupling matrix Kᵢₘ is defined as

$${K}_{im} ( t ) = {c}_{im} {\prod }_{p \neq i} ( 1 - {c}_{pm} {x}_{p} ) / 2 ,$$

where the definition of the coupling matrix cᵢₘ is provided above.

The mutual coupling matrix Kᵢₘ may check each clause m that contains spin xᵢ to determine whether the clause is satisfied by other literals. If spin xᵢ is in clause m, and none of the other literals satisfy this clause, then the embodiment disclosed herein may perturb xᵢ to try to satisfy the clause.

For example, for the following problem statement,

$$( {l}_{1} ⋁ \overline{{l}_{2}} ⋁ {l}_{5} ) ⋀ ( {l}_{2} ⋁ {l}_{3} ⋁ \overline{{l}_{4}} ) ⋀ ( \overline{{l}_{1}} ⋁ {l}_{4} ⋁ {l}_{6} ) ⋀ ( {l}_{3} ⋁ {l}_{4} ⋁ {l}_{5} )$$

a feedback term to x₄, z₄(t), is given by:

$${z}_{4} ( t ) = - \frac{1}{4} ( 1 - {x}_{2} ) ( 1 - {x}_{3} ) + \frac{1}{4} ( 1 + {x}_{1} ) ( 1 - {x}_{6} ) + \frac{1}{4} ( 1 - {x}_{3} ) ( 1 - {x}_{5} ) ,$$

where spin x₂ may correspond to literal l₂, spin x₃ may correspond to literal l₃, spin x₁ may correspond to literal l₁, spin x₆ may correspond to literal l₆, and spin x₅ may correspond to literal l₅. The above described formalism may also be described as follows: the feedback to x₄ is given by z₄(t)=K₄₂+K₄₃+K₄₄, where K₄₂=−½(1−x₂)(1−x₃), K₄₃=¼(1+x₁)(1−x₆), and K₄₄=¼(1−x₃)(1−x₅).

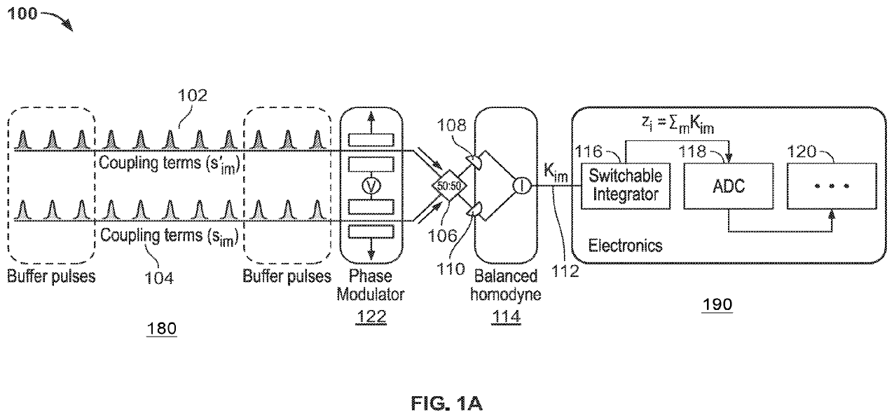

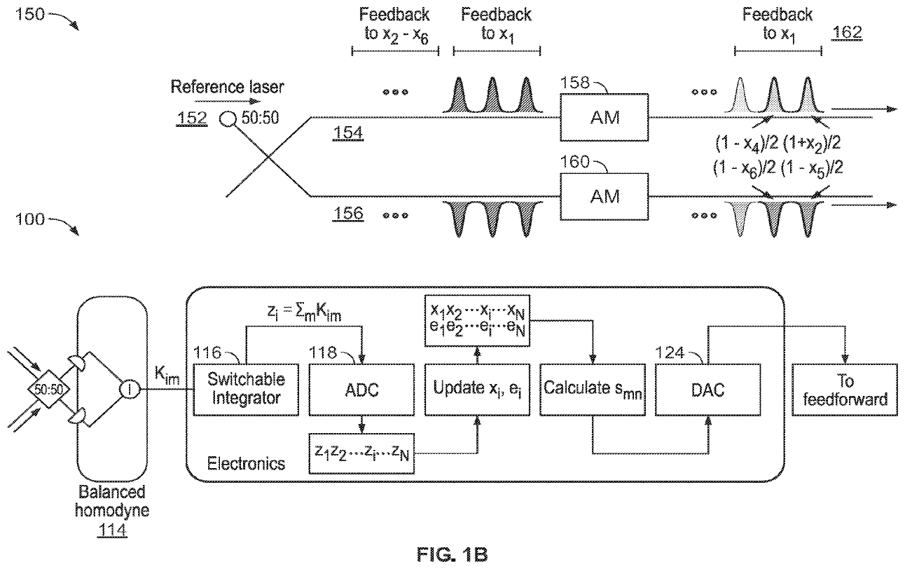

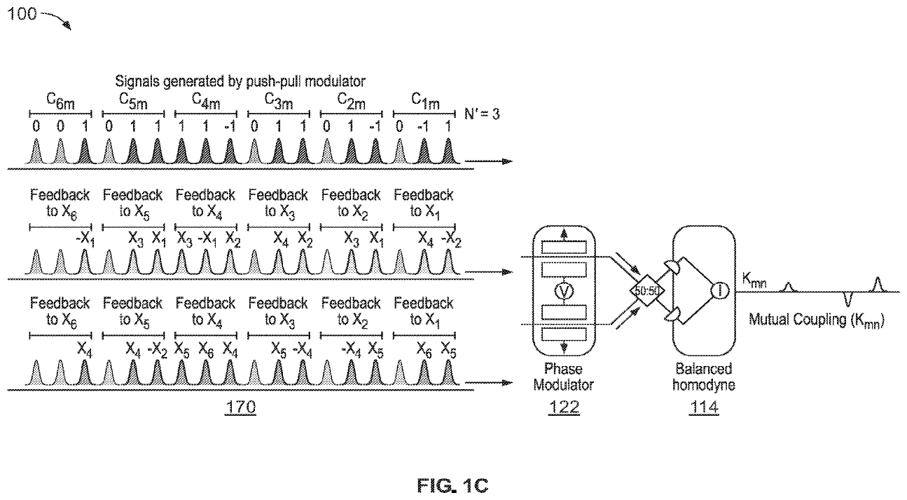

FIG. 1A shows an example optoelectronics circuit 100, according to example embodiments of this disclosure. The optoelectronics circuit may include an optical hardware 180 and an electronics hardware 190. The optoelectronics circuit 100 may be configured to calculate a feedback term for solving a Boolean satisfiability problem. Calculation of the feedback term may generally be the most expensive because the calculation includes matrix manipulations, as described above. As those skilled in the art understand, matrix manipulations are expensive to implement on electronics hardware 190. As such, utilizing the optical hardware 180 to perform these manipulations provides a drastic improvement in cost compared to electronics hardware 190. Other operations, however, may be performed in electronics hardware 190.

Particularly, for a 3-SAT problem, a feedback term zᵢ(t) may be a sum of pair wise products, as shown above (i.e., in the above example z₄(t) is a sum of K₄₂, K₄₃, K₄₄, each being a pair wise product). For example, the expression Kᵢₘ(t), whose sum over m clauses may be the feedback zᵢ(t), can be expressed as:

$${K}_{im} ( t ) = {c}_{im} {s}_{im}^{( 1 )} {s}_{im}^{( 2 )}$$

$${s}_{im}^{( 1 )} = ( 1 - {c}_{μ m} {x}_{μ} ) / 2$$

$${s}_{im}^{( 2 )} = ( 1 - {c}_{vm} {x}_{v} ) / 2$$

As shown, each mutual coupling term may be broken into two sub-terms

$${s}_{im}^{( 1 )} and {s}_{im}^{( 2 )} ,$$

hereinafter referred to as coupling terms. Furthermore, μ, ν may correspond to the first and second literals in clause m that are not lᵢ. Also, both

$${s}_{im}^{( 1 )} and {s}_{im}^{( 2 )}$$

may be real numbers between 0 and 1. The calculation will therefore be a multiplication of these two terms followed by the summing up of the pair-wise products over m. Such expression may be suited for a homodyne or a coherent receiver.

Therefore, the optoelectronics circuit 100 may be based on the principles of a homodyne receiver. In the circuit 100, a first train of pulses 102, representing the first coupling term

$${s}_{im}^{( 1 )} ;$$

and a second train of pulses 104, representing second coupling term

$${s}_{im}^{( 2 )} ,$$

are generated. Both trains of pulses 102, 104 may go through a 50:50 beam splitter 106 in a balanced homodyne receiver 114, so that the trains of pulses 102, 104 get mixed together. Based on the beam splitting, half the power of the first train of pulses 102 may go to the top detector 108 and the other half may go to the bottom detector 110. Similarly, half the power of the second train of pulses 104 may go to the top detector 108 and the other half may go to the bottom detector 110. The detection may be in form of photocurrents in each of the detectors 108, 110. The difference between the photocurrents in these two detectors 108, 110 may provide a product of the coupling sub-terms

$${s}_{im}^{( 1 )} and {s}_{im}^{( 2 )} .$$

That is, a pulse train of photocurrents (an electronic signal) indicating a sum of the coupling sub-terms may be seen on a wire 112. In other words, the electronic signal on the wire 112 may be proportional to the product of the two optical fields of the trains of pulses 102, 104.

The balanced homodyne receiver 114 may also perform an integration to generate the sum of pair-wise products. Particularly, diodes within the balanced homodyne receiver 114 may average the pulses—and, in performing the averages, perform a summation of the pulses (i.e., summation of the products of the trains of pulses 102, 104). Additionally, a switchable integrator 116 may be used for additional summing. For example, if the balanced homodyne receiver 114 performs a summation of ten pulses and a summation of a hundred pulses is desired, the switchable integrator 116 may perform the additional summations. As a result of these summations the zᵢ term is generated in an electronic domain. The zᵢ term may then be digitized using an analog to digital converter (ADC) 118 and sent to downstream electronic components (e.g., an FPGA) 120 to perform the remainder of the algorithm.

To get the cᵢₘ pre-factor, a push-pull phase modulator 122 may be used. If a voltage is applied to the phase modulator 122, a positive phase shift (+φ) is applied to the train of pulses 102 and a negative phase shift (−φ) is applied to the train of pulses 104; or vice versa. When this relative phase shift is applied, the balanced homodyne receiver 114 then measures

$${s}_{im}^{( 1 )} {s}_{im}^{( 2 )}$$

multiplied by the sine of the relative phase, i.e., in this case, each product is phase shifted by sin (2φ). The output of the balanced homodyne receiver 114 is therefore given by

$$\frac{1}{4} ( 1 - {c}_{μ m} {x}_{μ} ) ( 1 - {c}_{vm} {x}_{v} ) sin ( 2 φ ) .$$

Thus, the phase shift can be utilized to create all the values of cᵢₘ, i.e., 0, 1, and −1, by using the properties of sin(0) being 0, sin(π/2) being 1, and sin(−π/2) being −1. Therefore, the pre-factor is generated by the voltage on the phase modulator 122 and the coupling sub-terms may be based on the optical fields of the train of pulses 102, 104.

FIG. 1B shows an example optical circuit 150 configured to calculate a feedback term for the optoelectronics circuit 100, according to example embodiments of this disclosure. Particularly, the coupling sub-terms

$${s}_{im}^{( 1 )} and {s}_{im}^{( 2 )}$$

can be injected into the optoelectronics circuit 100 through the optical circuit 150. In some embodiments, the optical circuit 150 may be a part of the optoelectronics circuit 100. In the optical circuit 150, a reference laser 152 is received and split it into two paths: a first path 154 and a second path 156. Different time bins may be assigned to calculate the multiple feedback terms, e.g., a time bin containing a first subset of pulses can be used to calculate z₁, another time bin containing a second subset of pulses can be used to calculate z₂, and so on. For instance, the number of pulses for each zᵢ may be based on the structure of the problem. For the example encoding,

$$( {l}_{1} ⋁ \overline{{l}_{2}} ⋁ {l}_{5} ) ⋀ ( l ⋁ {l}_{3} ⋁ \overline{{l}_{4}} ) ⋀ ( \overline{{l}_{1}} ⋁ {l}_{4} ⋁ {l}_{6} ) ⋀ ( {l}_{3} ⋁ {l}_{4} ⋁ {l}_{5} )$$

the literal l₄ appears the most times, i.e., three times. Therefore, three pulses can be assigned for each zᵢ term—the three pulses can be considered a memory that may hold the information to be subsequently manipulated. Specifically, three pulses can be assigned as a first memory to calculate z₁, three pulses can be assigned as a second memory to calculate z₂, three pulses can be assigned as a third memory to calculate z₃, and so on. Therefore, each bin of three laser pulses in each of the two paths 154, 156 can be modulated using modulators 158, 160, respectively, into the sub terms

$${s}_{im}^{( 1 )} and {s}_{im}^{( 2 )} .$$

Because the sub-terms may be real numbers, the modulators 158, 160 can be amplitude modulators. For the first clause in the above example encoding, the laser pulses in the first path 154 may be modulated to (1+x₂)/2 (i.e., the corresponding sub-term

$${s}_{im}^{( 1 )} )$$

and laser pulses in the second path 156 may be modulated to (1−x₅)/2 (i.e., the corresponding sub-term

$${s}_{im}^{( 1 )} ) .$$

The next feedback may be from the clause where l₁ appears next, which is clause three in the above encoding. Accordingly, the corresponding laser pulses in the first path 154 may be modulated to (1−x₄)/2 and the laser pulses in the second path 156 may be modulated to (1−x₆)/2. There is no feedback to x₁ from the next clause, and therefore the terms (1−×4)/2 and (1−x₆)/2 when pair-wise multiplied and then summed, may generate the entire feedback 162 for x₁ (i.e., corresponding to l₁). The subsequent pulses (i.e., three pulses each) may be used for calculating feedback from the terms x₂ to x₆. Once the modulated pulses are generated, the pulses are sent to the balanced homodyne receiver 114 (as described above, with appropriate phase modulation) and to the electronics domain to integrate over the three pulses (i.e., by configuring the integrator 116 to integrate over a time corresponding to the three pulses). The resulting term from the integrator is z₂, which may then be digitized. The next three pulses may generate z₂, and the next three pulses may generate z₃, and so on and so forth; followed by digitization. The remainder of the algorithm may run in the electronics domain, i.e., to update xu and e; and to calculate all the sub terms. The calculated sub-terms may be converted into an analog domain using a digital to analog converter (DAC) 124 and sent back to the feedforward optical circuit 150. One iteration of algorithm is then complete, and the iterations are repeated.

The time benefit provided by the optoelectronics circuit 100 is the relatively faster calculation (i.e., matrix manipulation) in the optical domain. As described above, a fixed time window (i.e., containing a fixed number of pulses) is allocated to calculate each feedback signal. As further described above, in the example encoding,

$$( {l}_{1} ⋁ \overline{{l}_{2}} ⋁ {l}_{5} ) ⋀ ( l ⋁ {l}_{3} ⋁ \overline{{l}_{4}} ) ⋀ ( \overline{{l}_{1}} ⋁ {l}_{4} ⋁ {l}_{6} ) ⋀ ( {l}_{3} ⋁ {l}_{4} ⋁ {l}_{5} )$$

the literal l₄ appears three times, so that the memory will be set for N′=3 (i.e., three pulses for each sub-term.

FIG. 1C shows the specific optical encoding in the optoelectronics circuit 100, according to the example embodiments of this disclosure. The shown optical encodings 170 pertains to N′=3, i.e., three pulses for each sub-term. All the optical encodings 170 may therefore be blocks of three pulses. Particularly, the optical encodings 170 show what voltages are put in the phase modulator 122, and parallelly, what pulses are used to calculate the sub-terms, based on the expressions discussed above.

Using this heuristic of determining the number of pulses for each sub-term (i.e., based on the literal that appears the most), the memory requirement for the problem can be calculated. In other words, N′, the size of each bin is a function of problem size. The memory overhead for a constant integration time would therefore be T=N′T_{clock}. A Monte Carlo simulation may be performed for a fixed N and M=4.45 N for 500 instances. The largest number of occurrences in the instances is denoted by N′. Then, a distribution of N′ over these instances may be generated over the instances. In other words, a distribution of N′ as a function of N may be generated.

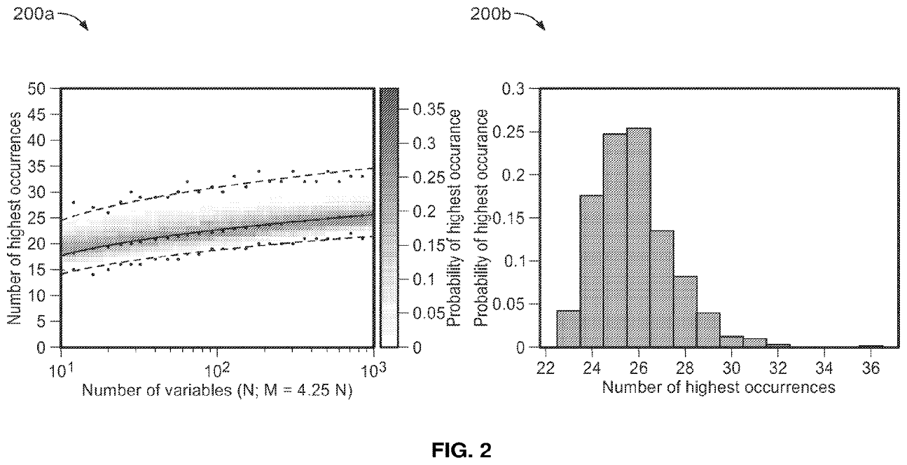

FIG. 2 shows charts 200a, 200b showing empirical results of Monte-Carlo simulation for the optoelectronics circuit 100, according to the example embodiments of this disclosure. As shown, for this simulation, the average number N′ is 25 (i.e., for N=1000 and M=4.25 M). Particularly, chart 200a shows average of the distribution along with its upper and lower bounds (with the lines as fits and the dots as the actual measured values). A safety factor of 1.5 may be used to generate N′=36, which would cover all the sampled instances. So, even if there are 1000 variables, only 36 pulses are needed to encode the feedback.

Then, the scaling of N′ with problem size may be determined. It may be empirically found that that the mean of memory size <N′> was found to be scale up extremely slow, given by the following expression:

$$< {N}^{′} >= 12 + 7 log ( log ( N ) )$$

Therefore, if N′=50, it would be sufficient for even for extremely large problem sizes, (e.g., N=10¹⁰⁰). So, a simple design would be to set N′=50 for all the problem sizes.

This sparse optical encoding therefore provides a significant improvement because of the low memory overhead even for large problem sizes. Even if the feedback calculation overhead is included, it was found that the speed increases linearly with the problem size. This can be contrast with conventional full matrix multiplication where the scaling would be quadratic with problem size.

Furthermore, this algorithm can be parallelized by using many balanced homodyne receivers. This also provides a significant improvement over conventional electronics-based calculation. For example, it was empirically found that the parallelization with just 16 balanced homodyne receiver provides a significant scale advantage over conventional electronic systems.

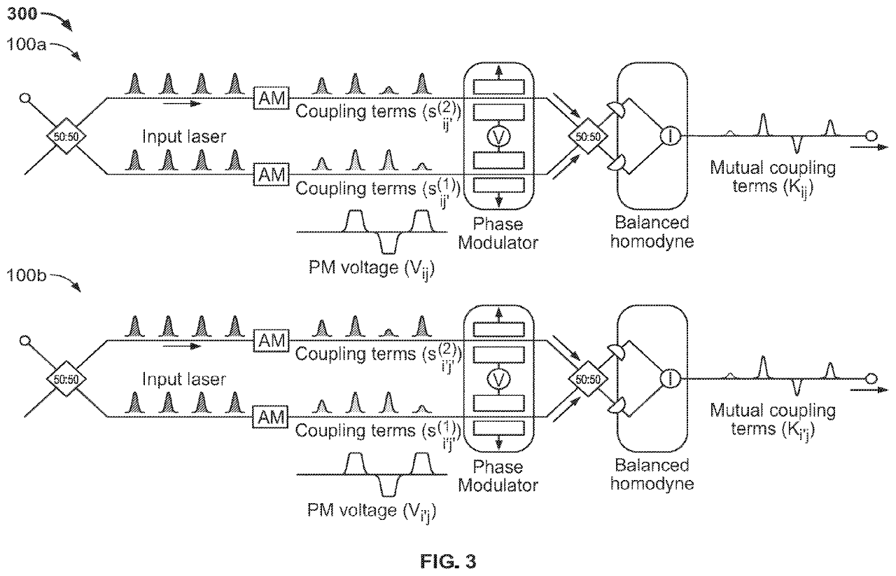

FIG. 3 shows an example parallelized optoelectronics circuit 300, according to example embodiments of this disclosure. In particular, two copies of optoelectronics circuit 100 (labeled as 100a and 100b), with the individual components and corresponding functionalities as described with regards to FIGS. 1A-1C, are shown.

To take advantage of the sparsity, an optical random access memory may be needed. In other words, a system is needed that can store x₁, x₂, x₃, . . . as pulses of light, but to be read and fanned out to the encodings described above. The encoding can have many copies of each variable- or a rearranging of pulses anywhere in time is needed. Furthermore, few general operations may have to be supported by the system. The operations include addition and multiplication (between rails) and optical vector-vector multiplication, which multiplies two rails and accumulates over time (the function done by the balanced homodyne receiver in the above example). The difference here is that the output is a light, rather than a voltage of the homodyne receiver.

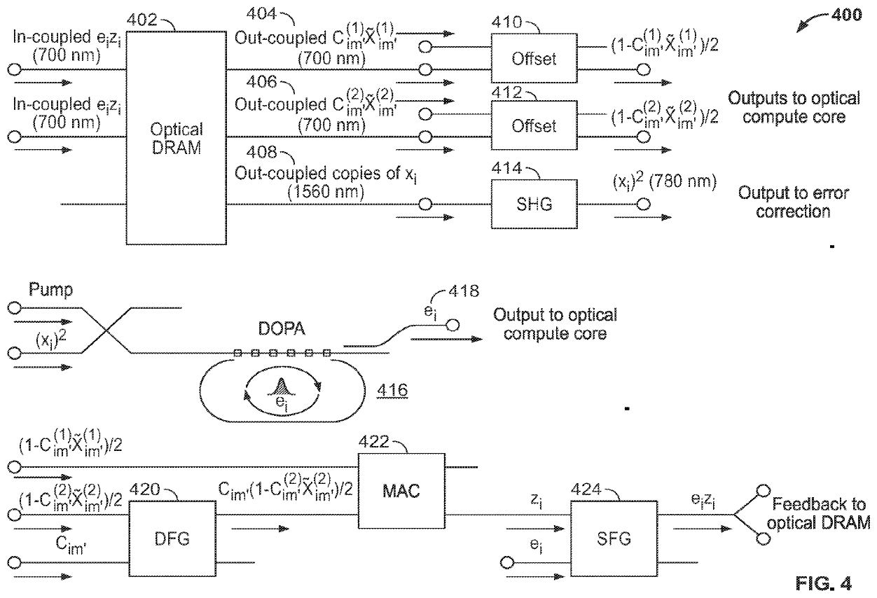

FIG. 4 shows an all-optical computing system 400, according to example embodiments of this disclosure. Within the computing system 400, an optical dynamic random access memory (optical DRAM) 402 is shown. It may be necessary for the outputs to be read from the optical DRAM 402. The first output 404 may be for the first sub-term and the second output 406 may be for the second sub-term. The third output 408 may be a copy of xᵢ. For the first output 404 an offset 410 may done to subtract the first output 404 from 1, and for the first the second output 406 another offset 412 may be done to subtract the second output 406 from 1. In other words, the subtraction (offsetting) may generate the first sub-term and the second sub-term. For the third output 408, a second harmonic generator (SHG) 414 may square the output 408 to generate xᵢ². In addition to squaring the input term, the SHG 414 may change the wavelength (e.g., from 1560 nm to 780 nm). The output of the SHG 414 may be used to calculate the error correction terms by feeding into an error correction circuit 416 to generate the error (eᵢ) variables 418. These variables 418 can be read and fed to other circuits.

To calculate eᵢzᵢ, the first sub-term and the sign cᵢₘ term may be fed to a difference frequency generator (DFG) 420. The DFG 420 may multiply the input fields together and may output a corresponding product at a different wavelength. Particularly, the DFG 420 may perform an element wise multiplication and generate an output of a changed color. This output and the second sub term may be combined in a multiply and accumulate (MAC) circuit 422, which may multiply the inputs and generate the sum of the products over the index m′. The output of the MAC circuit 422 may therefore be zᵢ (i.e., the sum of the pair-wise products). Then the output zᵢ and the error term eᵢ is fed into a sum frequency generator (SFG) 424, which may multiply the two inputs and also changes the wavelength of the output (back to 700 nm). The output may then be fed back to the optical DRAM 402, thereby completing an iteration of the algorithm. The general sequence of operation for each iteration may therefore be: (a) read out from memory and prepare outputs; (b) calculate the coupling sub-terms; (c) multiply-and-accumulate the sub-terms to get feedback terms; and (d) inject feedback into the optical memory.

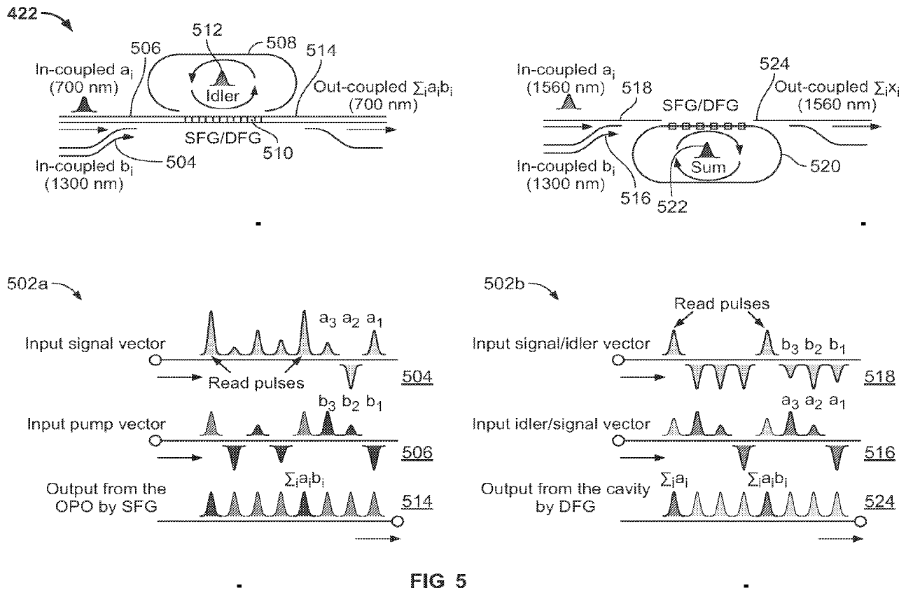

FIG. 5 shows the details of the MAC circuit 422, according to example embodiments of this disclosure. MAC circuit 422 may be configured to perform a multiplication across rails and accumulate (i.e., integrate) the products in time. Two examples 502a, 502b of the MAC circuit 422 have been shown.

In the first example 502a, a first signal 504 at 1300 nm and a second signal 506 with a shorter wavelength of 700 nm are shown. The first signal 504 and the second signal 506 may then be combined in a waveguide 508. It is known in the art that when the different wires with the optical signals are coupled together, the longer wavelengths can jump from one rail to the next without having the short wavelengths jump over. Therefore, the first signal 504 can jump over to the rail with the shorter wavelength second signal 506, without perturbing the shorter wavelength. When the combined signals pass through a non-linear section, the signals may generate a 1560 nm idler 512. If the idler 512 is synchronized with the pulses coming in, the idler 512 may line up with the pulses coming in the non-linear section 510 and the process is repeated. In other words, the next two pulses will also undergo the differential frequency generation and add to the existing idler 512. The result is, if the first signal 504 encodes a₁, a₂, a₃; and if the second signal 506 encodes b₁, b₂, b₃, the eventual idler 512 may encode a₁b₁+a₂b₂+a₃b₃. To output the result, the shorter wave may be stopped and only the longer wave of 1300 nm may be used (i.e., a bright read pulse), which may perform frequency generation with the idler 512 to outputs 514, a₁b₁+a₂b₂+a₃b₃ as a 700 nm wave.

In a second example 502b, two long wave inputs: first input 516 and second input 518 are shown. These inputs 516, 518 may be combined in a rail and injected into a loop to pass through a non-linear crystal 520 to perform a frequency generation to generate a short wavelength, which moves around in a cavity. A sum pulse 522, generated after three pulses of input, therefore may carry the value a₁b₁+a₂b₂+a₃b₃. Similar to the above, a bright read pulse of the longer wavelength input 518 may be used to read the output 524 as 1560 nm light.

There may, however, be differences between the two examples 502a, 502b. In the case of sum frequency generation, i.e., example 502b, the first generated pulse c₁ may be given by the product of the two inputs a₁ and b₁ augmented by a constant κ. Mathematically, this may be shown as:

$${c}_{1} = κ {a}_{1} {b}_{1} .$$

The second pulse may then be c₂=c₁+κa₂b₂ and the third pulse is c₃=c₂+κa₃b₃, and so on and so forth. Therefore, the N^{th} pulse may become cₙ=κΣⱼaⱼbⱼ. But, in reality, there may be a loss to limit the fidelity of the feedback. The N^{th} pulse is actually cₙ=κₐₙbₙ+r cₙ₋₁, where (r<1). In other words, the N^{th} pulse may include a signal from the previous feedback multiplied by a feedback coefficient r. That means, when the light is looping around the cavity, not all energy is recovered and there may be some loss.

In the first example 502a, such loss may be mitigated by providing some amplification around the cavity (i.e., optical parametric amplification). Mathematically, the optical parametric amplification may be provided by cₙ=bₙ sinh(κaₙ)+rcₙ₋₁ cosh(κaₙ). Assuming a condition of low gain, this equation becomes cₙ=κbₙaₙ+rcₙ₋₁(1+(κaₙ)²/2). Therefore, if <(1+(κaₙ)²/2)>=1/r, the entire product ab; can be recovered. In other words, if <(1+(κaₙ)²/2) is the gain imparted by the pump, then effect of the feedback coefficient r may be nullified. Therefore, using the first example 502a, a high fidelity sums of the fields may be achieved, and the output light can be used in the computations.

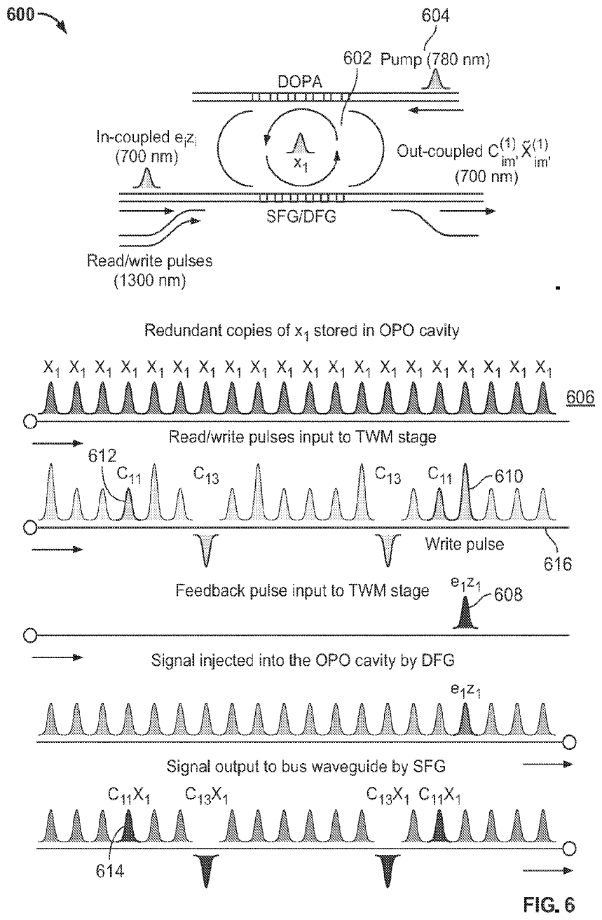

FIG. 6 shows an example memory 600 configured to optically store a variable, according to example embodiments of this disclosure. An example goal of the memory 600 may be to store copies of each xᵢ and read these stored signals out to the sparse optical encoding described above. As shown, the memory 600 may include a cavity 602 to store xᵢ for it to loop around in a circle. In some embodiments, xᵢ may be a telecom signal at 1560 nm. A pump pulse 604 of 780 nm may be used to pump the cavity 602, causing a gain to xᵢ on every round trip. Having the round trip and the gain can do a portion of differentiation

$${\partial }_{t} {x}_{i} ( t ) = ( p - 1 ) {x}_{i} ( t ) - {x}_{i}^{3} ( t )$$

to model the evolution of xᵢ. Furthermore, another signal may have to be fed to the cavity 602 to inject feedback to the cavity 602 or to read the signal in the cavity 602.

Particularly, graph 606 (to be read from right to left) shows a train of pulses x₁ going around in the cavity 602. A feedback 608 (e₁z₁) may have to be injected back into the cavity 602. A bright write pulse 610 may be used to perform a difference frequency generation to produce x₁+e₁z₁ in the cavity 602. Injecting the feedback term may apply a full equation of motion to model the evolution of x₁. For reading from the cavity 602, if there is an input pulse 612 (C₁₁) and there are no blue pulses, a frequency generation is performed in the cavity 602 to generate a readout 614 (C₁₁x₁) from the cavity 602. Therefore, a rail 616 can be used for a sequence of comments to address the memory enabled by the cavity 602—to write to the memory and to read out from the memory.

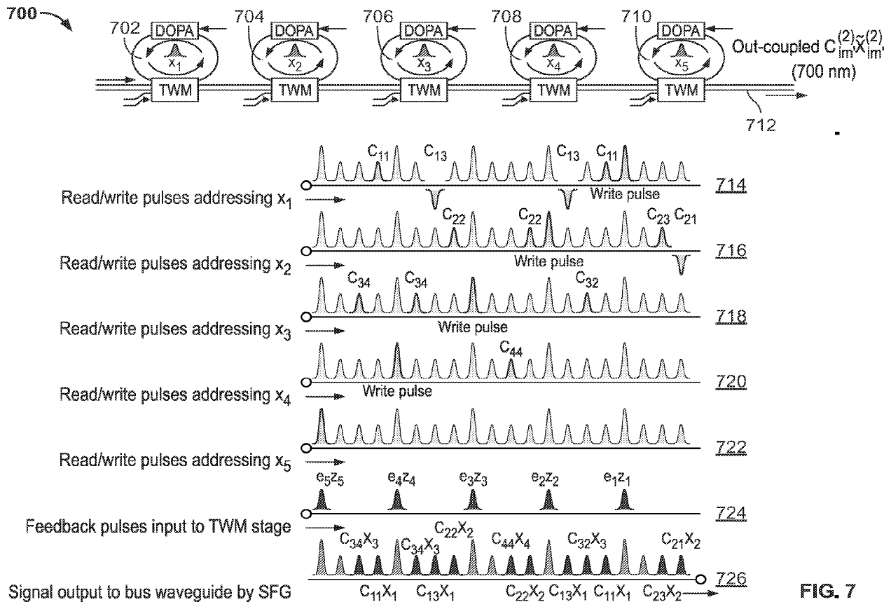

FIG. 7 shows an example optical random access memory 700, according to example embodiments of this disclosure. As shown, the optical random access memory 700 is configured to be used for solving the following problem:

$$( {l}_{1} ⋁ \overline{{l}_{2}} ⋁ {l}_{5} ) ⋀ ( l ⋁ {l}_{3} ⋁ \overline{{l}_{4}} ) ⋀ ( \overline{{l}_{1}} ⋁ {l}_{4} ⋁ {l}_{6} ) ⋀ ( {l}_{3} ⋁ {l}_{4} ⋁ {l}_{5} )$$

For the terms x₁, x₂, x₃, x₄, x₅; optical cavities 702, 704, 706, 708, 710, respectively, are used. A same pump (not shown) may be used to pump all the optical cavities 702, 704, 706, 708, 710. Each of the optical cavities 702, 704, 706, 708, 710, however, can be addressed separately through the sum frequency generation or different frequency generation (shown as three-wave mixing). All the optical cavities 702, 704, 706, 708, 710 may also sharing the same bus waveguide 712. When a readout is performed from one of the cavities, the result may be put in the same bus waveguide 712. For addressing the cavities 702, 704, 706, 708, 710 for the first sub-term, different pulse sequences 714, 716, 718, 720, 722, respectively, are shown.

Particularly, the feedback to x₁ is from l̅₂, C₂₁ may be −1 in the pulse sequence 716 addressing x₂. Furthermore, the effect of l₂ from clause 3 is shown as C₂₃=1 in the pulse sequence 716. These two pulses in the pulse sequence 716 may address x₂. Furthermore, these pulses may be assigned to the first block because they are being used to calculate the feedback to x₁. Feedbacks to other variables may be calculated similarly in the subsequent blocks, as shown. At the end, the final pulse sequence 726 shows the combination of all feedbacks in different blocks. These feedbacks can be offset, as described above, to generate the sub-terms. The feedback pulses are shown in pulse sequence 724, which are injected into the corresponding cavity using the corresponding write pulses, as shown.

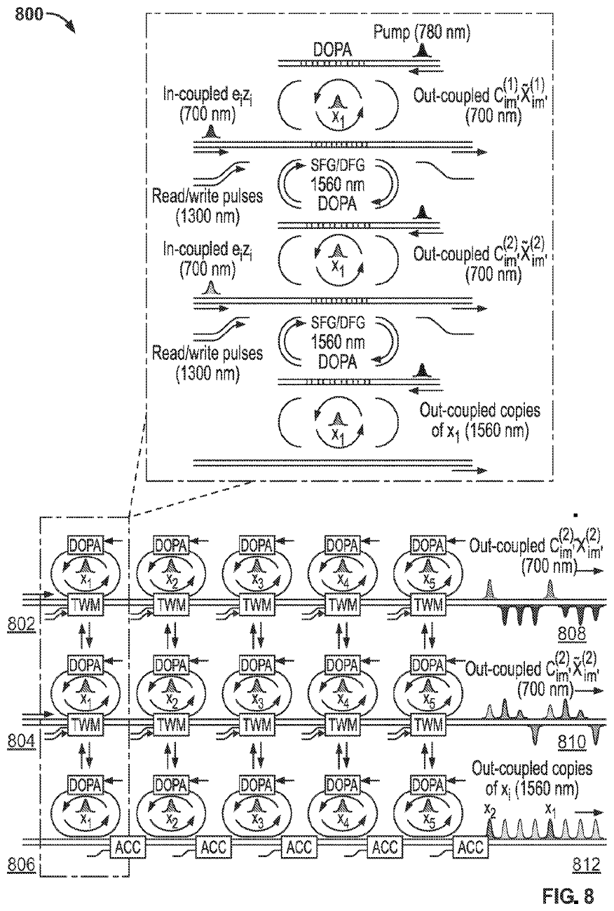

FIG. 8 shows a layout 800 of an optical chip, according to example embodiments of this disclosure. Particularly, the shown layout 800 has three rails 802, 804, 806, with the first rail 802 being addressed to generate first sub-terms, the second rail 804 being addressed to generate the second sub-terms, and the third rail 806 being addressed to generate copies of x₁ and x₂ that are used to make the error correction terms. In other words, the two rails 802, 804 are similar to the layout shown in FIG. 7 and described above. The third rail 806, instead of doing sum and difference frequency generation to generate pulses, may let the pulses leak out of the cavity to perform multiply and accumulate. The pulses may be made sparse in this fashion. The first and second outputs 808, 810 can then be offset to generate the sub-terms. The third output 812 can be sent to a second harmonic generate to square the pulses and then sent to the calculation circuits, and after the calculations, inject the results back into the memory.

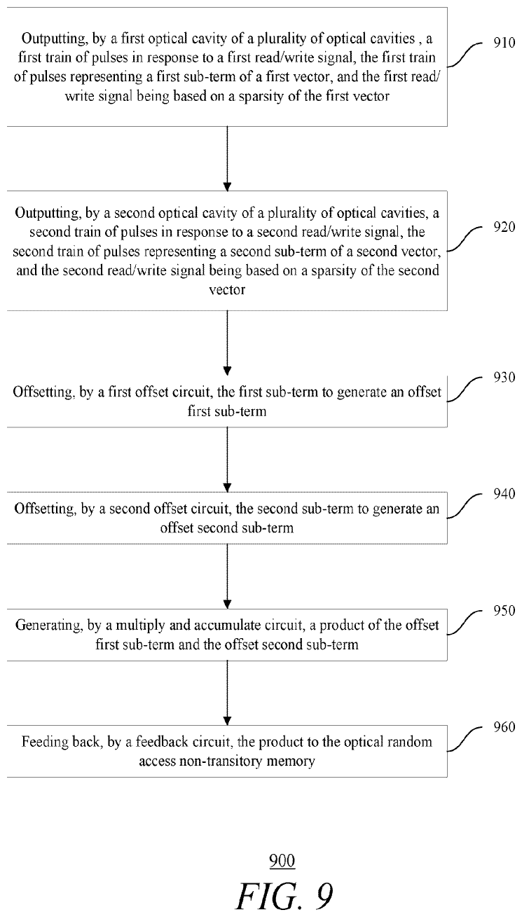

FIG. 9 shows a flow diagram of an example method 900 of optical computing, according to example embodiments of this disclosure. It should be understood that the steps of the method 900 are just for illustration and should not be considered limiting. Methods with additional, alternative, or fewer number of steps should be considered within the scope of this disclosure. In some embodiments, the method 900 may be performed by an optical computing system having an optical non-transitory memory formed by a plurality of optical cavities and an optical processing circuit, as described throughout this disclosure.

The method may begin at step 910, where a first optical cavity of the plurality of optical cavities may output a first train of pulses in response to a first read/write signal. The first train of pulses may represent a first sub-term of a first vector, and the first read/write signal may be based on a sparsity of the first vector.

At step 920, a second optical cavity of the pluralities of optical cavities may output a second train of pulses in response to a second read/write signal. The second train of pulses may represent a second sub-term of a second vector, and the second read/write signal may be based on a sparsity of the second vector.

At step 930, a first offset circuit of the optical processing circuit may offset the first sub-term to generate an offset first sub-term.

At step 940, a second offset circuit of the optical processing circuit may offset the second sub-term to generate an offset second sub-term.

At step 950, a multiply and accumulate circuit of the optical processing circuit may generate a product of the offset first sub-term and the offset second sub-term.

At step 960, a feedback circuit of the optical processing circuit may feed back the product to the optical random access non-transitory memory.

In some embodiments, the aforementioned steps may form an iteration of an optical domain multiplication between the first vector and the second vector. This multiplication may be a part of solving a Boolean satisfiability problem.

### Example Embodiments

In some embodiments, an optical encoder for generating a vector-vector product includes a first rail configured to run a first train of pulses, wherein a portion of the first train of pulses represents a first sub-term of a first vector; a second rail configured to run a second train of pulses, wherein a portion of the second train of pulses represents a second sub-term of a second vector, wherein each of the portion of the first train of pulses and the portion of the second train of pulses is selected based on the sparsity of the first vector and the second vector; and a balanced homodyne receiver configured to generate a product of the portion of the first train of pulses and the portion of the second train of pulses in an optical domain.

The optical encoder of the paragraph above, wherein each of the first train of pulses and the second train of pulses include coherent pulses.

The optical encoder of any of the paragraphs above, wherein the portion of the first train of pulses is based on the time required to encode the first sub-term, and wherein the portion of the second train of pulses is based on the time required to encode the second sub-term.

The optical encoder of claim any of the paragraphs above, further including: an optical modulator configured to shift the relative phase between the first train of pulses and the second train of pulses.

The optical encoder of any of the paragraphs above, wherein the balanced homodyne receiver is further configured to provide the product as an electronic signal to an electronic circuit.

The optical encoder of any of the paragraphs above, further configured to receive optical feedback from the electronic circuit.

The optical encoder of any of the paragraphs above, further including a first modulator configured to modulate the portion of the first train of pulses to represent the first sub-term and a second modulator configured to modulate the portion of the second train of pulses to represent the second sub-term.

The optical encoder of any of the paragraphs above, wherein both of the first train of pulses and the second train of pulses are generated by a same reference laser.

The optical encoder of any of the paragraphs above, wherein the balanced homodyne receiver is configured at least partially integrate the product of the portion of the first train of pulses and the portion of the second train of pulses with one or more other pairwise products.

The optical encoder of any of the paragraphs above, wherein the product is configured to be used for solving a Boolean satisfiability problem.

In some embodiments, method of optically generating a vector-vector product includes running, on a first rail of an optical encoder, a first train of pulses, wherein a portion of the first train of pulses represents a first sub-term of first vector; running, on a second rail of the optical encoder, a second train of pulses, wherein a portion of the second train of pulses represents a second sub-term of second vector, wherein each of the portion of the first train of pulses and the portion of the second train of pulses is selected based on the sparsity of the first vector and the second vector; and generating, by a balanced homodyne receiver of the optical encoder, a product of the portion of the first train of pulses and the portion of the second train of pulses in an optical domain.

The method of the paragraph above, wherein each of the first train of pulses and the second train of pulses include coherent pulses.

The method of any of the paragraphs above, wherein the portion of the first train of pulses is based on the time required to encode the first sub-term, and wherein the portion of the second train of pulses is based on the time required to encode the second sub-term.

The method of any of the paragraphs above, further including: shifting, by an optical modulator of the optical encoder, relative phase between the first train of pulses and the second train of pulses.

The method of any of the paragraphs above, further including: providing, by the balanced homodyne receiver, the product as an electronic signal to an electronic circuit.

The method of any of the paragraphs above, further including: receiving, by the optical encoder, optical feedback from the electronic circuit.

The method of any of the paragraphs above, further including: modulating, by a first modulator of the optical encoder, the portion of the first train of pulses to represent the first sub-term; and modulating, by a second modulator of the optical encoder, the portion of the second train of pulses to represent the second sub-term.

The method of any of the paragraphs above, further including: generating, by a same reference laser of the optical encoder, both of the first train of pulses and the second train of pulses.

The method of any of the paragraphs above, further including: at least partially integrating, by the balanced homodyne receiver, the vector-vector product of the portion of the first train of pulses and the portion of the second train of pulses with one or more other vector-vector products.

The method of any of the paragraphs above, further including: using the product for solving a Boolean satisfiability problem.

In some embodiments, optical circuit for generating a vector-vector product includes an optical dynamic random access memory configured to output a first sub-term of a first vector and a second sub-term of a second vector; a first offset circuit configured to offset the first sub-term and a second offset circuit configured to offset the second sub-term; and a multiply and accumulate circuit configured to generate a product of the offset first sub-term and the offset second sub-term.

The optical circuit of the paragraph above, further including: a difference frequency generator configured to augment one of the offset first sub-term or the offset second sub-term based on a coupling matrix.

The optical circuit of any of the paragraphs above, wherein the multiply and accumulate circuit is configured to generate the product of either the offset first sub-term or the offset second sub-term with the remaining sub-term.

The optical circuit of claim any of the paragraphs above, further including: an error term generating circuitry configured to inject an error factor into the product.

The optical circuit of any of the paragraphs above, wherein the product with the error factor is configured to be fed back to the optical dynamic random access memory.

The optical circuit of any of the paragraphs above, wherein the multiply and accumulate circuit is further configured to integrate the product with pair-wise products of other sub-terms.

The optical circuit of any of the paragraphs above, wherein the product is configured to be fed back to the optical dynamic random access memory.

The optical circuit of any of the paragraphs above, wherein the product is configured to be fed back to the optical dynamic random access memory as 700 nm laser pulses.

The optical circuit of any of the paragraphs above, wherein each of the first sub-term and the second sub-term are outputted by the optical dynamic random access memory as 700 nm laser pulses.

The optical circuit of any of the paragraphs above, wherein the product is configured to be used for solving a Boolean satisfiability problem.

In some embodiments, a method for optically generating a vector-vector product includes outputting, by an optical dynamic random access memory, a first sub-term of a first vector and a second sub-term of a second vector; offsetting, by a first offset circuit, the first sub-term and offsetting, by a second offset circuit, the second sub-term; and generating, by a multiply and accumulate circuit, a product of the offset first sub-term and the offset second sub-term.

The method of the paragraph above, further including: augmenting, by a difference frequency generator, one of the offset first sub-term or the offset second sub-term based on a coupling matrix.

The method of any of the paragraphs above, further including: generating, by the multiply and accumulate circuit, the product of either the offset first sub-term or the offset second sub-term with the remaining sub-term.

The method of any of the paragraphs above, further including: an error term generating circuitry configured to inject an error factor into the product.

The method of any of the paragraphs above, further including: feeding back, the product with the error factor, to the optical dynamic random access memory.

The method of any of the paragraphs above, further including: integrating, by the multiply and accumulate circuit, the product with pair-wise products of other sub-terms.

The method of any of the paragraphs above, further including: feeding back the product to the optical dynamic random access memory.

The method of any of the paragraphs above, further including: feeding back the product to the optical dynamic random access memory as 700 nm laser pulses.

The method of any of the paragraphs above, further including: outputting, by the optical dynamic random access memory, each of the first sub-term and the second sub-term as 700 nm laser pulses.

The method of any of the paragraphs above, further including: using the product is configured to be used to solve a Boolean satisfiability problem.

In some embodiments, an optical random access memory includes a plurality of optical cavities, each cavity configured to store a variable as resonating optical pulses; and for each cavity, a first rail configured to provide an input to the cavity, a second rail configured to provide read/write signal to the cavity, and a third rail configured to receive output from the cavity.

The optical random access memory of the paragraph above, wherein each optical cavity includes a degenerate optical parametric oscillator.

The optical random access memory of any of the paragraphs above, wherein the input to the cavity is injected using a difference frequency generator.

The optical random access memory of any of the paragraphs above, wherein the output from the cavity is outputted by a sum frequency generator.

The optical random access memory of any of the paragraphs above, wherein the plurality of optical cavities are arranged in multiple rows, each row sharing a bus waveguide.

The optical random access memory of any of the paragraphs above, wherein the outputs across each of the multiple rows are configured to be read out in parallel.

The optical random access memory of any of the paragraphs above, wherein at least one of the multiple rows is configured to output error correction pulses.

The optical random access memory of any of the paragraphs above, wherein the encoding for the variable is pre-allocated based on the sparsity of the matrix containing the variable.

The optical random access memory of any of the paragraphs above, wherein the encoding for the variable is pre-allocated in an as-needed basis.

The optical random access memory of any of the paragraphs above, configured to be used for solving a Boolean satisfiability problem.

In some embodiments, a method of optically storing variables includes storing, in each cavity of a plurality of optical cavities, a variable as resonating optical pulses; and for each cavity, providing input through a first rail, providing a read/write signal through a second rail, and receiving an output from the cavity through a third rail.

The method of the paragraph above, wherein each optical cavity includes a degenerate optical parametric oscillator.

The method of any of the paragraphs above, further including: injecting the input to the cavity using a difference frequency generator.

The method of any of the paragraphs above, further including: outputting the output from the cavity by using a sum frequency generator.

The method of any of the paragraphs above, wherein the plurality of optical cavities are arranged in multiple rows, each row sharing a bus waveguide.

The method of any of the paragraphs above, further including: reading out in parallel, outputs across each of the multiple rows.

The method of any of the paragraphs above, further including: outputting, by at least one of the multiple rows, error correction pulses.

The method of any of the paragraphs above, wherein the encoding for the variable is pre-allocated based on the sparsity of the matrix containing the variable.

The method of any of the paragraphs above, wherein the encoding for the variable is pre-allocated in an as-needed basis.

The method of claim any of the paragraphs above, used for solving a Boolean satisfiability problem.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. An optical computing system, comprising:
an optical random access non-transitory memory comprising:
a plurality of optical cavities, each optical cavity configured to store a variable as resonating optical pulses, each optical cavity being optically connected to: an input rail configured to provide an input to the optical cavity, a signal rail configured to provide a read/write signal to the optical cavity, and an output rail configured receive an output from the optical cavity;
a first optical cavity of the plurality of optical cavities configured to output a first train of pulses in response to a first read/write signal, the first train of pulses representing a first sub-term of a first vector, and the first read/write signal being based on a sparsity of the first vector; and
a second optical cavity of the plurality of optical cavities configured to output a second train of pulses in response to a second read/write signal, the second train of pulses representing a second sub-term of a second vector, and the second read/write signal being based on a sparsity of the second vector; and
an optical processing circuit comprising:
a first offset circuit configured to offset the first sub-term and a second offset circuit configured to offset the second sub-term;
a multiply and accumulate circuit configured to generate a product of the offset first sub-term and the offset second sub-term; and
a feedback circuit configured to feed back the product to the optical random access non-transitory memory.

2. The optical computing system of claim 1, wherein each of the first train of pulses and the second train of pulses comprise coherent pulses.

3. The optical computing system of claim 1, wherein the first read/write signal is based on a time required to encode the first sub-term, and wherein the second read/write signal is based on a time required to encode the second sub-term.

4. The optical computing system of claim 1, the optical processing circuit further comprising:
an optical modulator configured to shift a relative phase between the first train of pulses and the second train of pulses.

5. The optical computing system of claim 1, the optical processing circuit further comprising:
a difference frequency generator configured to augment one of the offset first sub-term or the offset second sub-term based on a coupling matrix.

6. The optical computing system of claim 1, wherein the multiply and accumulate circuit is configured to generate the product of either the offset first sub-term or the offset second sub-term with a remaining sub-term.

7. The optical computing system of claim 1, the optical processing circuit further comprising:
an error term generating circuit configured to inject an error factor into the product.

8. The optical computing system of claim 7, wherein the feedback circuit is configured to feed back the product with the error factor to the optical random access non-transitory memory.

9. The optical computing system of claim 1, wherein the multiply and accumulate circuit is further configured to integrate the product with pair-wise products of other sub-terms.

10. The optical computing system of claim 1, wherein the plurality of optical cavities are arranged in multiple rows, each row sharing a bus waveguide.

11. The optical computing system of claim 10, wherein outputs across each of the multiple rows are configured to be read out in parallel.

12. The optical computing system of claim 10, wherein at least one of the multiple rows is configured to output error correction pulses.

13. A method performed by an optical computing system, the method comprising:
outputting, by a first optical cavity of a plurality of optical cavities forming an optical random access non-transitory memory, a first train of pulses in response to a first read/write signal, the first train of pulses representing a first sub-term of a first vector, and the first read/write signal being based on a sparsity of the first vector;
outputting, by a second optical cavity of a plurality of optical cavities, a second train of pulses in response to a second read/write signal, the second train of pulses representing a second sub-term of a second vector, and the second read/write signal being based on a sparsity of the second vector;
offsetting, by a first offset circuit, the first sub-term to generate an offset first sub-term;
offsetting, by a second offset circuit, the second sub-term to generate an offset second sub-term;
generating, by a multiply and accumulate circuit, a product of the offset first sub-term and the offset second sub-term; and
feeding back, by a feedback circuit, the product to the optical random access non-transitory memory.

14. The method of claim 13, wherein each of the first train of pulses and the second train of pulses comprise coherent pulses.

15. The method of claim 13, wherein the first read/write signal is based on a time required to encode the first sub-term, and wherein the second read/write signal is based on a time required to encode the second sub-term.

16. The method of claim 13, further comprising:
shifting, by an optical modulator, a relative phase between the first train of pulses and the second train of pulses.

17. The method of claim 13, further comprising:
augmenting, by a difference frequency generator, one of the offset first sub-term or the offset second sub-term based on a coupling matrix.

18. The method of claim 13, further comprising:
generating, by the multiply and accumulate circuit, a product of either the offset first sub-term or the offset second sub-term with a remaining sub-term.

19. The method of claim 13, further comprising:
injecting, by an error term generating circuit, an error factor into the product.

20. The method of claim 19, further comprising:
feeding back, by the feedback circuit, the product with the error factor to the optical random access non-transitory memory.
